(19) United States
(12) Patent Application Publication
(10) Pub. No.: US 2020/0097673 A1
(43) Pub. Date: Mar. 26, 2020

(54) DATA PRIVILAGE CONTROL METHOD AND SYSTEM

(71) Applicants: Fu Tai Hua Industry (Shenzhen) Co., Ltd., Shenzhen (CN); HON HAI PRECISION INDUSTRY CO., LTD., New Taipei (TW)

(72) Inventors: FU-FA CAI, Shenzhen (CN); XIN LU, Shenzhen (CN); HUI-FENG LIU, Shenzhen (CN); YU-YONG ZHANG, Shenzhen (CN)

(73) Assignees: Fu Tai Hua Industry (Shenzhen) Co., Ltd., Shenzhen (CN); HON HAI PRECISION INDUSTRY CO., LTD., New Taipei (TW)

(21) Appl. No.: 16/253,512

(22) Filed: Jan. 22, 2019

(30) Foreign Application Priority Data
Sep. 26, 2018 (CN) 201811126013.8

(51) Int. Cl. G06F 21/62; G06F 12/14; H04L 29/06

(52) U.S. Cl. CPC G06F 21/6218; G06F 12/1491; H04L 63/102; G06F 2221/2141; H04L 63/107; H04L 63/108; H04L 63/105

(57) ABSTRACT

A data privilege control method includes configuring user metadata, dynamically configuring user classification according to the user metadata, dynamically configuring data read and write privilege according to the user classification, receiving a user access request, obtaining the user attributes and determining the user classification according to the user attributes, determining whether the user has a data read and write privilege according to the user classification, and authorizing the user's data read and write operations when it is determined that the user has data read and write privilege. The user metadata includes a number of user attributes.

### FIELD

The subject matter herein generally relates to data privilege control systems, and more particularly to a dynamic data privilege control method and system.

### BACKGROUND

At present, with the popularization of Internet applications and the development of information technology, various data systems are widely used in enterprise and society. There are more and more information databases, and requirements for data access control are becoming higher and higher. Traditional methods of data access control mostly adopt a static data access control mode. However, when a user's attributes change, a role of the user needs to be manually changed in the database.

### BRIEF DESCRIPTION OF THE DRAWINGS

Implementations of the present disclosure will now be described, by way of embodiments, with reference to the attached figures.

FIG. 1 is a flowchart of a data privilege control method.

FIG. 2 is a flowchart of a method of configuring a data read and write privilege.

FIG. 3 is a block diagram of a data privilege control system.

FIG. 4 is a block diagram of a computing device.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series and the like.

In general, the word “module” as used hereinafter refers to logic embodied in hardware or firmware, or to a collection of software instructions, written in a programming language such as, for example, Java, C, or assembly. One or more software instructions in the modules may be embedded in firmware such as in an erasable-programmable read-only memory (EPROM). It will be appreciated that the modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

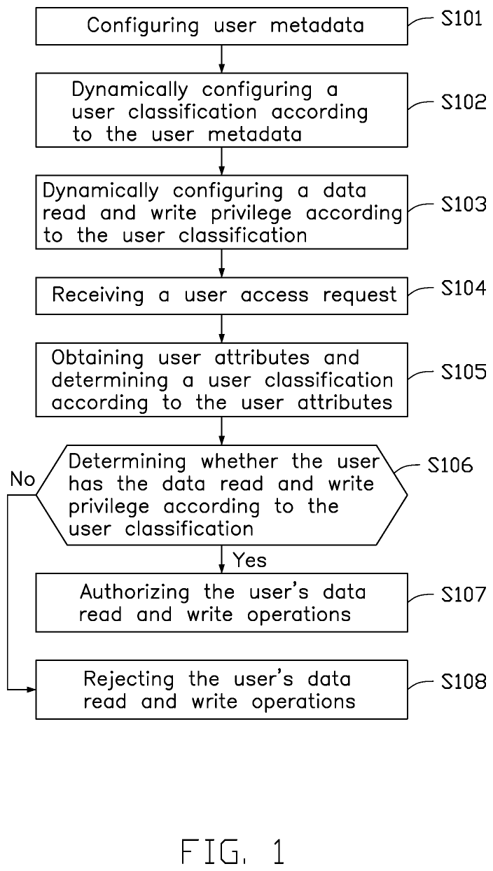

FIG. 1 is a flowchart of a data privilege control method. The order of the blocks in the flowchart may be changed according to different requirements, and some blocks may be omitted or combined.

At block S101: user metadata is configured. The user metadata includes multiple attributes of a user.

In one embodiment, the configuration of the user metadata is performed by using Extensible Markup Language (XML) technology, and a configuration file describes multiple attributes and types of each attribute of each user, and the types of the attributes may be a number or a string. The attribute includes an identity attribute of the user. The identity attribute includes an age, education, occupation, gender, and the like of the user. If the user is a company employee, the identity attribute also includes the user's level, department, job type, project group, and the like.

When the user metadata is configured, the metadata may be linked to at least one external system, such as a company personnel system. When there is a change in the level, department, job type, project group, or other identity attribute in the personnel system, the metadata is automatically updated to dynamically configure the user's new privilege.

In one embodiment, the attribute further includes one or more of a network environment in which the user is located, an electronic device used, a geographical location where the user is located, a time of user access, or other preset scenarios. In one embodiment, the network environment in which the user is located, the electronic device used, the geographical location where the user is located, the access time of the user, or other preset scenarios may be linked to the company monitoring system by the user metadata. When the company monitoring system detects a change in the user attributes, the user metadata is dynamically updated correspondingly. In another embodiment, the user's network environment can be obtained using technologies such as IP tracking to ensure that the user is logged in with a limited use IP address. The electronic device used can determine whether it is a limited electronic device by a computer name or MAC address to login. The location of the user can be identified by using an identification device such as a camera. The time of user access can be determined by acquiring clock information in the electronic device. Other predetermined situations are determined on a case-by-case basis.

At block S102, a user classification is dynamically configured according to the user metadata.

In one embodiment, the user classification is configured by using dynamic rules according to the user metadata. Therefore, when a user's attributes change, the user category belonging to the user will also change, so there is no need to manually change the user classification.

The dynamic rules are described in terms of expressions, which may include numbers, strings, arithmetic operators, and logical operators, and the expressions may also include context sensitive variables and functions.

For example, dynamic rules for user classification include the following expressions:

userInfo.groupLevel=1

userInfo.groupLevel=2

userInfo.groupLevel=3

A user metadata configuration file includes the user's attribute “groupLevel”. According to the above expressions, when “groupLevel” is 1, the user is classified as a group user. When “groupLevel” is 2, the user is classified as a sub-group user. When “groupLevel” is 3, the user is classified as business group user.

In one embodiment, the network environment in which the user is located is divided into a company intranet and an external network, and the users are classified as intranet users and extranet users according to the network environment as described by the users in the user metadata.

At block S103, a data read and write privilege is dynamically configured according to the user classification.

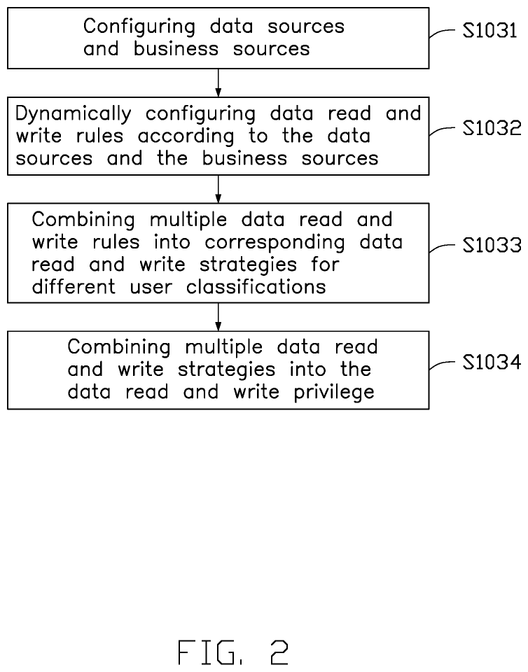

Referring to FIG. 2, block S103 includes the following blocks.

At block S1031, data sources and business sources are configured.

In one embodiment, a data source engine obtains database table information through Open Database Connectivity (ODBC) technology to configure the data sources. Data is obtained by a business source engine, and the data is stored in a specified business model, thereby configuring the business sources.

At block S1032, data read and write rules are dynamically configured according to the data sources and the business sources.

In one embodiment, the data read and write rules are configured by dynamic rules according to the data sources and the business sources. The dynamic rules are described in terms of expressions, which may include numbers, strings, arithmetic operators, logical operators, and context sensitive variables and functions.

The data read and write rules include rules for data reading and data writing. Data reading refers to a range of data that the user is allowed to query, including a range of data columns and a range of data rows. Data writing refers to allowing the user to operate on business content, such as allowing the user to write, upload, or download information.

At block S1033, multiple data read and write rules are combined into corresponding data read and write strategies for different user classifications.

At block S1034, multiple data read and write strategies are combined into the data read and write privilege.

In one embodiment, a rule “the group user's single loan amount is not more than 5000 yuan on the day” is configured according to the following expression:

curUser.groupLevel=1

[AND]

Loan.Money<5000

[AND]

Loan.Date=Today( )

Through the above configuration, the “group user” can initiate a loan of no more than 5,000 yuan and write a loan record into the system database table.

At block S104, a user access request is received.

At block S105, user attributes are obtained, and a user classification is determined according to the user attributes.

In one embodiment, the user attributes are obtained by searching the configured user metadata. The user attributes include identity attributes, such as age, education, occupation, gender, and the like. If the user is a company employee, the identity attributes also include the user's level, department, job type, project group, and the like. Since the user metadata has been configured in block S101, the user metadata can be obtained quickly to save data transmission time.

In another embodiment, the user attributes are obtained by querying at least one external system. Therefore, when the user attributes in the external system change, the latest user attributes can be obtained by querying the external system. The external system may be a personnel system, a company monitoring system, or the like. The user attributes may include an identity attribute of the user, and the user attribute may further include at least one of a network environment in which the user is located, an electronic device used, a geographical location where the user is located, a time of user access, or other preset context. In one embodiment, by querying the personnel system, the latest user attributes are obtained. Thus, a storage capacity of local user metadata is saved.

After obtaining the user attributes, the user classification is determined according to the dynamic rules. When the user attributes change, the user classification also may change.

In one embodiment, if the “groupLevel” in the identity attribute acquired by the personnel system has changed from “2” to “1”, the user classification is changed from “sub-group” to “group”.

At block S106, whether the user has the data read and write privilege is determined according to the user classification.

Specifically, rule analysis, strategy analysis, and privilege analysis are performed according to the user classification and the configured data read and write privilege of the user, so as to determine whether the user has the data read and write privilege. If the user has the data read and write privilege, block S107 is implemented. If the user does not have the data read and write privilege, block S108 is implemented.

For example, when the data read and write permission for “query the current user's company and subsidiary information” is assigned to the “group” and “intranet” users, it is determined that the “group” user using the intranet has data read and write privilege.

At block S107, the user's data read and write operations are authorized.

After authorization, the user has the corresponding data read and write privilege to read and write data.

At block S108, the user's data read and write operations are rejected.

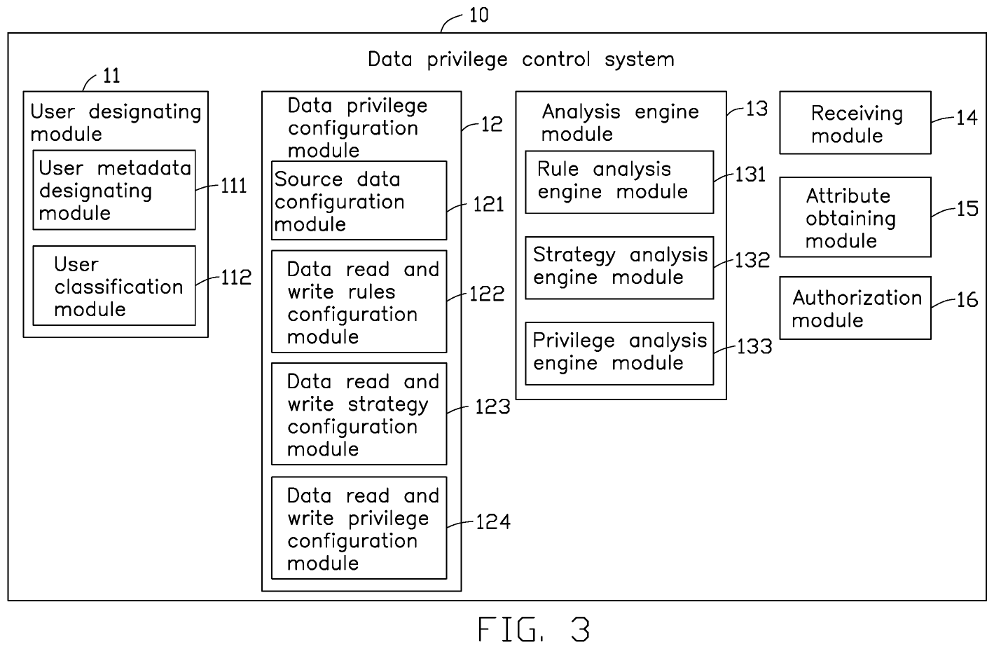

FIG. 3 is a block diagram of an embodiment of a data privilege control system 10. The data privilege control system 10 may include one or more modules, which may be stored in a memory of a computing device and may be configured to be processed by one or more processors. For example, as shown in FIG. 3, the data privilege control system 10 includes a user designating module 11, a data privilege configuration module 12, an analysis engine module 13, a receiving module 14, an attribute obtaining module 15, and an authorization module 16.

The user designating module 11 defines and classifies users by using dynamic rules of user classification. The user designating module 11 includes a user metadata designating module 111 and a user classification module 112. The user metadata designating module 111 defines the user metadata, and the user classification module 112 dynamically configures the user classification according to the user metadata. In one embodiment, a configuration file of the user metadata describes a plurality of user attributes and a type of each attribute. The user attributes include the identity attribute of the user, and the user attributes may also include one or more of the network environment in which the user is located, an electronic device used, a geographic location in which the user is located, a time of user access, or other predetermined context. The user classification module 112 configures the user classification by the dynamic rules according to the user metadata.

The data privilege configuration module 12 dynamically configures the data read and write privilege according to the user classification. The data privilege configuration module 12 includes a source data configuration module 121, a data read and write rules configuration module 122, a data read and write strategy configuration module 123, and a data read and write privilege configuration module 124. The source data configuration module 121 reads the database table information and the business source information according to a request, thereby configuring the data source and the business source. The data read and write rules configuration module 122 dynamically configures rules for reading and writing data according to the data source and the business source. The data read and write strategy configuration module 123 combines the multiple data read and write rules into corresponding data read and write strategies for different user classifications. The data read and write privilege configuration module 124 combines multiple data read and write strategies into the data read and write privilege.

Specifically, the user classification module 112 uses dynamic rules to configure the user classification. The data privilege configuration module 12 uses the dynamic rules to configure the data read and write privilege. The dynamic rules are described by using an expression. The expression may include a number, strings, arithmetic operators, and logical operators, which can also include context-sensitive variables and functions.

The analysis engine module 13 analyses the data read and write privilege according to the request to determine whether the user has the corresponding data read and write privilege. The analysis engine module 13 includes a rule analysis engine module 131, a strategy analysis engine module 132, and a privilege analysis engine module 133. The rule analysis engine module 131 analyzes the read and write rules according to the request. The strategy analysis engine module 132 analyzes the read and write strategies according to the request. The privilege analysis engine module 133 analyzes the read and write privilege according to the request, thereby determining whether the user has the read and write privilege.

The receiving module 14 receives a user access request.

The attribute obtaining module 15 obtains a plurality of user attributes. The user attributes include an identity attribute of the user and at least one of a network environment in which the user is located, an electronic device used, a geographical location where the user is located, a time of user access, or other preset context.

In one embodiment, the attribute obtaining module 15 obtains the user attributes by querying the user metadata stored in the data privilege control system 10.

In another embodiment, the data privilege control system 10 establishes communication with at least one external system, so that the attribute obtaining module 15 acquires the user attributes by querying the at least one external system. The external system may be a company personnel system, a company monitoring system, or the like.

The authorization module 16 authorizes or rejects the user's data read and write operations.

The above-described data privilege control method and system can dynamically configure the user classification. When the user attributes change, the user classification belonging to the user may also change. Thus, the user classification is not required to be manually changed. The data read and write privilege is dynamically configured according to the user classification to achieve dynamic control of the user data read and write privilege. Since the user privilege changes with a change in the user attributes, security of the system is improved. In addition, the above method and system dynamically configure the data read and write privilege according to the user classification without the need to manually configure data read and write privileges for each user attribute, thereby reducing a workload and improving efficiency of data management and control. Further, the data permission control method and system described above configure the data read and write privilege through dynamic rules. When the data of the business sources change, only the configuration of the relevant rules need to be changed, and privilege control is separated from business logic to facilitate system expansion.

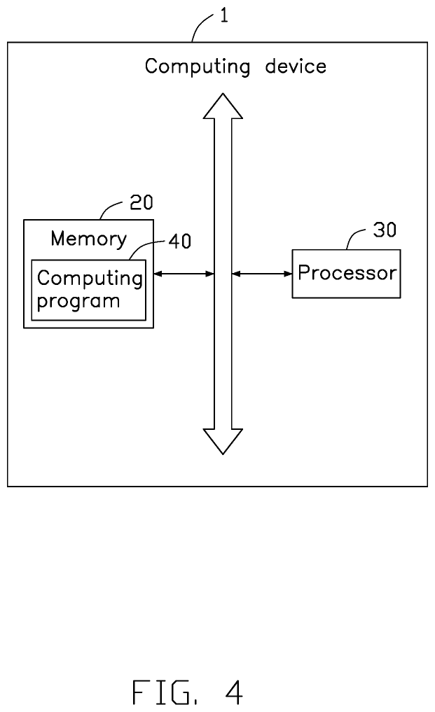

FIG. 4 shows an embodiment of a computing device.

The computing device 1 includes a memory 20, a processor 30, and a computer program 40 stored in the memory 20 and executable by the processor 30. When the processor 30 executes the computer program 40, the blocks in the embodiment of the data privilege control method are implemented. Alternatively, when the processor 30 executes the computer program 40, the functions of the modules in FIG. 3 are implemented.

The computer program 40 can be partitioned into one or more modules that are stored in the memory 20 and executed by the processor 30. The one or more modules may be a series of computer program instruction segments capable of performing a particular function, the instruction segments being used to describe the execution of the computer program 40 in the computing device 1. For example, the computer program 40 can be divided into the user designating module 11, the data privilege configuration module 12, the analysis engine module 13, the receiving module 14, the attribute obtaining module 15, and the authorization module 16.

The computing device 1 may be a desktop computer, a notebook, a palmtop computer, or a cloud server. It will be understood by those skilled in the art that the schematic diagram is merely an example of the computing device 1, and does not constitute a limitation of the computing device 1, and may include more or less components than those illustrated, and some components may be combined or be different. Components such as the computing device 1 may also include input and output devices, network access devices, buses, and the like.

The processor 30 may be a central processing unit (CPU), or may be other general-purpose processors, a digital signal processor (DSP), an application specific integrated circuit (ASIC), a Field-Programmable Gate Array (FPGA), or other programmable logic device, discrete gate or transistor logic device, discrete hardware components, or the like. The general purpose processor may be a microprocessor or the processor 30 may be any conventional processor or the like, and the processor 30 is a control center of the computing device 1 and connects the entire computing device 1 by using various interfaces and lines.

The memory 20 can be used to store the computer program 40 and/or modules by running or executing computer programs and/or modules stored in the memory 20. The memory 20 may mainly include a storage program area and a storage data area, wherein the storage program area may store an operating system, an application required for at least one function (such as a sound playing function or an image playing function), and the like. Data and the like created according to the use of the computing device 1 are stored. In addition, the memory 20 may include a high-speed random access memory, and may also include a non-volatile memory such as a hard disk, a memory, a plug-in hard disk, a smart memory card (SMC), and a secure digital (SD) card, flash card, at least one disk storage device, flash device, or other volatile solid-state storage device.

The modules integrated by the computing device 1 can be stored in a computer readable storage medium if implemented in the form of a software functional unit and sold or used as a standalone product. Based on such understanding, the present disclosure implements all or part of the processes in the foregoing embodiments, and may also be completed by a computer program to instruct related hardware. The computer program may be stored in a computer readable storage medium. The steps of the various method embodiments described above may be implemented when the program is executed by the processor. The computer program includes computer program code, which may be in the form of source code, object code form, executable file, or some intermediate form. The computer readable medium may include any entity or device capable of carrying the computer program code, a recording medium, a USB flash drive, a removable hard disk, a magnetic disk, an optical disk, a computer memory, a Read-Only Memory (ROM), Random access memory (RAM), electrical carrier signals, telecommunications signals, and software distribution media. It should be noted that the content contained in the computer readable medium may be appropriately increased or decreased according to the requirements of legislation and patent practice in a jurisdiction, for example, in some jurisdictions, according to legislation and patent practice, computer readable media does not include electrical carrier signals and telecommunication signals.

In the several embodiments provided by the present disclosure, it should be understood that the disclosed computer apparatus and method may be implemented in other manners. For example, the computing device embodiments described above are merely illustrative.

In addition, each functional unit in each embodiment of the present disclosure may be integrated in the same processing unit, or each unit may exist physically separately, or two or more units may be integrated in the same unit. The above integrated unit can be implemented in the form of hardware or in the form of hardware plus software function modules.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A data privilege control method comprising:
configuring user metadata, the user metadata comprising a plurality of user attributes;
dynamically configuring user classification according to the user metadata;
dynamically configuring data read and write privilege according to the user classification;
receiving a user access request;
obtaining the user attributes and determining the user classification according to the user attributes;
determining whether the user has a data read and write privilege according to the user classification; and
authorizing the user's data read and write operations when it is determined that the user has data read and write privilege.

2. The data privilege control method of claim 1, wherein:
the user attributes comprise identity attributes and one or more of a network environment in which the user is located, an electronic device used by the user, a geographic location where the user is located, a time of user access, or other preset context.

3. The data privilege control method of claim 1, wherein dynamically configuring data read and write privilege comprises:
configuring data sources and business sources;
dynamically configuring data read and write rules according to the data sources and the business sources;
combining multiple data read and write rules into corresponding data read and write strategies for different user classifications; and
combining multiple data read and write strategies into the data read and write privilege.

4. The data privilege control method of claim 3, wherein:
the user classification and data read and write privilege are configured by dynamic rules;
the dynamic rules are described by expressions comprising numbers, strings, arithmetic operators, and logical operators.

5. A computing device comprising:
a processor; and
a memory storing a plurality of instructions, which when executed by the processor, cause the processor to:
configure user metadata, the user metadata comprising a plurality of user attributes;
dynamically configure user classification according to the user metadata;
dynamically configure data read and write privilege according to the user classification;
receive a user access request;
obtain the user attributes and determine the user classification according to the user attributes;
determine whether the user has a data read and write privilege according to the user classification; and
authorize the user's data read and write operations when it is determined that the user has data read and write privilege.

6. The computing device of claim 5, wherein:
the user attributes comprise identity attributes and one or more of a network environment in which the user is located, an electronic device used by the user, a geographic location where the user is located, a time of user access, or other preset context.

7. The computing device of claim 5, wherein the processor dynamically configures the data read and write privilege by:
configuring data sources and business sources;
dynamically configuring data read and write rules according to the data sources and the business sources;
combining multiple data read and write rules into corresponding data read and write strategies for different user classifications; and
combining multiple data read and write strategies into the data read and write privilege.

8. The computing device of claim 7, wherein:
the user classification and data read and write privilege are configured by dynamic rules;
the dynamic rules are described by expressions comprising numbers, strings, arithmetic operators, and logical operators.

9. A non-transitory storage medium having stored thereon instructions that, when executed by a processor of a computing device, causes the processor to execute instructions of a data privilege control method, the method comprising:
configuring user metadata, the user metadata comprising a plurality of user attributes;
dynamically configuring user classification according to the user metadata;
dynamically configuring data read and write privilege according to the user classification;
receiving a user access request;
obtaining the user attributes and determining the user classification according to the user attributes;
determining whether the user has a data read and write privilege according to the user classification; and
authorizing the user's data read and write operations when it is determined that the user has data read and write privilege.

10. The non-transitory storage medium of claim 9, wherein:
the user attributes comprise identity attributes and one or more of a network environment in which the user is located, an electronic device used by the user, a geographic location where the user is located, a time of user access, or other preset context.

11. The non-transitory storage medium of claim 9, wherein dynamically configuring data read and write privilege comprises:
configuring data sources and business sources;
dynamically configuring data read and write rules according to the data sources and the business sources;
combining multiple data read and write rules into corresponding data read and write strategies for different user classifications; and
combining multiple data read and write strategies into the data read and write privilege.

12. The non-transitory storage medium of claim 11, wherein:
the user classification and data read and write privilege are configured by dynamic rules;
the dynamic rules are described by expressions comprising numbers, strings, arithmetic operators, and logical operators.
